(19) United States
(12) Patent Application Publication
(10) Pub. No.: US 2013/0092802 A1
(43) Pub. Date: Apr. 18, 2013

(54) Line Extender/Retractor

(71) Applicant: Andrew J. Doberstein, Hartford, WI (US)

(72) Inventor: Andrew J. Doberstein, Hartford, WI (US)

(21) Appl. No.: 13/272,374

(22) Filed: Oct. 13, 2011

(51) Int. Cl. F16L 3/01

(52) U.S. Cl. 248/70

(57) ABSTRACT

A line extender/retractor device supports a line member, such as an electrical or plumbing line, extending between a housing and a movable closure, such as a cabinet and door of an appliance. The device can have complementary parts coupled together and to the appliance to allow for movement of the door. One or both of the parts defines one or more troughs allowing the line member to extend through the device between the housing and closure. The two parts can snap together with complementary mating features. An integral mounting feature on one or both of the parts can support a component of a switch mechanism, such as a magnet of a magnetically actuated switch, to operate an electrical feature, such as a light within a cabinet interior.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND

1. Technical Field

The present disclosure relates to line management devices, and in particular to devices for electrical and plumbing lines extending to movable items.

2. Description of the Related Art

Commercial and household appliances, such as refrigerators, beverage coolers, ice machines, trash compactors, dish washers, washer and dryer machines and the like, often have a cabinet or housing with an access opening that is closed by a door or like closure member. It is also often the case that the door contains electrical, plumbing or other remote components that are connected to the cabinet via movable or flexible lines. Opening and closing the door requires these utility lines to move, for example by translating, hinging, or moving in a complex translating and pivoting motion. This movement can lead to damage to the lines from wear, pinching or crimping causing leaking or shorting of the lines and loss of operation of the remote device(s).

Brackets, conduits and crossover tubes have been devised to support utility lines running between the cabinets and doors of appliances and the like. For example, U.S. Pat. No. 5,263,509 discloses a rigid tube for routing utility lines from the cabinet to the door of a refrigerator. One end of the tube is pivotally coupled to the door and the other end slides within an open space in the cabinet. Thus, the rigid tube moves with the utility line to reduce damage to the line as it extends across the gab between the cabinet and the opening door. Similarly, U.S. Pat. No. 4,912,942 discloses a rigid crossover tube for routing water and electrical conduit from the cabinet to the door of a refrigerator. Again, the tube pivots at the door and slides with the conduit with respect to the cabinet. However, in both cases, the simple hollow tube construction of the devices does not prevent relative movement of the lines with respect to the tubes, nor are the lines secured at the entry to the tubes, such that it is possible for the lines to become damaged by binding or pinching against the tubes themselves.

U.S. Pub. Appl. 2007/0194675 discloses a stationary device for utility lines that are routed from the cabinet to the door of a refrigerator. Specifically, the publication discloses routing the lines through a cord support attached to a stationary hinge bracket at the lower door hinge. The cord support forms a large channel holding bundled cords and ribs within the channel secure the cord from moving relative to the cord support. However, as mentioned, this device is stationary and inflexible, and does not span the gap between the cabinet and the door, such that the chords are unsupported and susceptible to damage.

Accordingly, further refinements are needed to address the noted problems of the existing art.

### BRIEF SUMMARY

The disclosure relates to improved extender/retractor devices for use in commercial and household appliances, such as cool storage units and the like.

Specifically, in one aspect the extender/retractor device can support a line member extending between a housing and a movable closure. The device can have two parts. A first part has a first end coupled to one of the housing and the closure and a second end coupled to the other of the housing and the closure. The first part can have a back and sides defining a channel therebetween having an open side. The second part is coupled to the first part and can close the open side of the channel. At least one of the parts defines a trough for receiving the line member. The trough opens to the channel and at the ends of the device so that the line member can extend therethrough and between the housing and the closure. One or more additional troughs can be provided to accommodate additional elongated members or to facilitate left-hand, right-hand mounting interchangeability.

In another aspect the disclosure provides a two-part extender/retractor device. The first part can have a back and sides defining a channel therebetween, and the second part can be coupled to the first part within the channel. One part, such as the second part, can define a trough for receiving the line member. The trough opens at ends of the device so that the elongated member can extend between the housing and the closure. One of the parts, such as the first part, or both parts together, can be connected to the housing or closure in a sliding connection via a lengthwise slot in the back wall and can be connected to the other of the housing and closure via a pivotal connection.

In still another aspect the disclosure provides a two-part extender/retractor device with one or more troughs for receiving the line member such that it can extend between the housing and the closure. One or both of the parts can be connected to the housing at one end and to the closure at the other end. The first part can have a back and sides defining a channel therebetween. The sides of the first part can have inwardly extending projections defining catch surfaces. The second part can be coupled to the first part within the channel in a snap-fit. The second part can have outwardly extending projections that are engaged the catch surfaces to retain the second part to the first part. The projections of the first part can have tapered cam surfaces for easing insertion of the projections of the second part past the catch surfaces when assembling the second part into the first part.

Another aspect of the disclosure is the provision of a switch mount that can be attached to, or formed integrally with, one or both parts of the extender/retractor device. For example, an integral mounting feature of one of the parts can support a component of a switch mechanism, such as a magnet of a magnetically actuated switch, to operate an electrical feature, such as a light within a cabinet interior.

These and other advantages will be apparent from the following detailed description of the drawings. To assess the full scope of the invention the claims should be looked to as the construction(s) shown in the drawings and described below are not limiting.

### BRIEF DESCRIPTION OF THE DRAWINGS

FIG. 1 is a perspective view of an exemplary appliance in the form of a cooling unit having an extender/retractor device according to one embodiment of the disclosure;

FIG. 2 is an enlarged partial perspective view thereof showing the extender/retractor device;

FIG. 3 is a bottom plan view thereof showing the extender/retractor device in a retracted position as when the door of the cooling unit is closed;

FIG. 4 is an enlarged partial bottom plan view thereof;

FIG. 5 is an enlarged partial bottom plan view thereof with the extender/retractor device in an extended position as when the door of the cooling unit is open;

FIG. 6 is a partial side sectional view taken along line 6-6 of FIG. 4; and

FIG. 7 is a partial front sectional view taken along line 7-7 of FIG. 4.

### DETAILED DESCRIPTION OF THE DRAWINGS

This disclosure pertains to utility chord and line management devices, such as for electrical wires and plumbing conduit. The device can be used for routing such utility lines between two components, especially where at least one component is movable with respect to the other. For example, appliances of various types, including kitchen appliances, such as refrigerators, wine cabinets, ice makers, trash compactors, dish washers and the like, and other household or commercial appliances, such as washers and dryers and the like, commonly have a stationary base or cabinet to which a door is mounted to allow access into the base or cabinet. Remote features, such as electronic or mechanical controls and water spouts coupled to the utility lines, may be mounted to the door. In order to permit such door mounted features, the lines must be able to extend and retract to accommodate the movement associated with opening and closing the door. One way to achieve this is for the lines to be flexible and able to bend in and out along with the door. The disclosed device facilitates movement and support of utility lines as they extend and retract. Also, although the device can be utilized for various appliances, as well as other items with cabinets and doors, for simplicity the following description of the accompanying drawings pertains to a cool storage appliance.

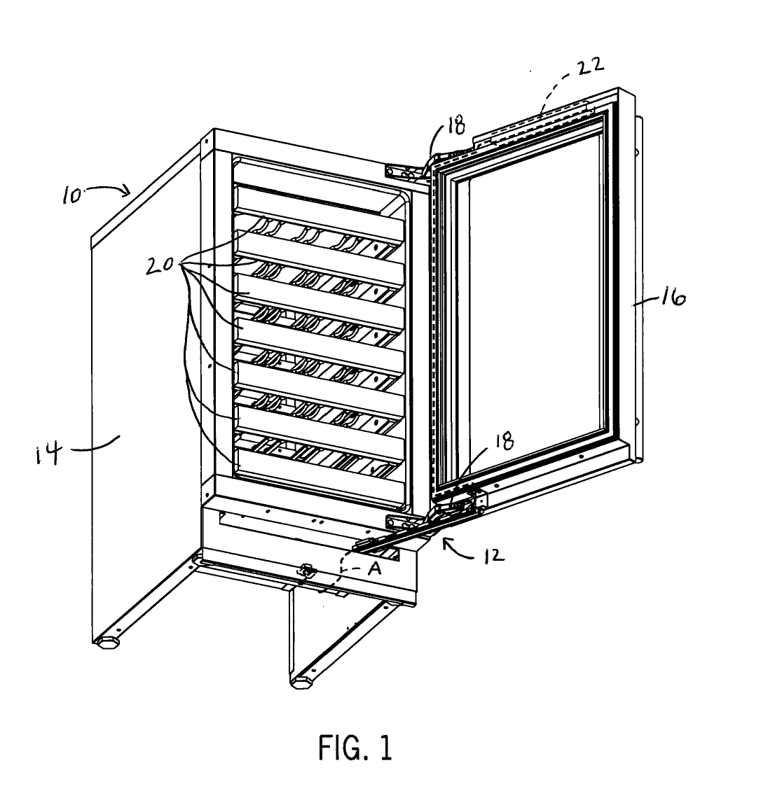

FIG. 1 of the drawings shows one example of a cooling unit 10 having an extender/retractor device 12. By way of example, the cooling unit 10 can be any self-contained cold storage unit, such as a refrigerator, freezer, ice maker, a wine and/or beverage cooler, and combinations thereof. The cooling unit 10 generally includes a thermally insulated cabinet 14 defining a storage cavity with an access opening at the front face of the cabinet 14. The opening is sealed by a thermally insulated door 16 pivotally mounted to the front of the cabinet 14 by upper and lower hinges 18. The cooling unit 10 includes a compressor, a capillary tube, and interior and exterior heat exchanger coils containing a standard refrigerant, as known in the art, for lowering the temperature of the air inside the cabinet 14. The compressor and exterior coil are contained in a compartment in the bottom of the cabinet 14, which is accessible from the back side of the unit (not shown). One or more extendable racks 20 can be located in the cooled space within the cabinet to support food or drink items, such as wine bottles. An electronic control unit 22 is mounted to the door 16 along the top edge. The control unit 22 can have a circuit board with a low-voltage portion and a high-voltage portion. The control unit can be configured to receive a desired storage cavity air temperature to be maintained from a user input, receive and/or determine the storage cavity air temperature, maintain the storage cavity air temperature at the desired temperature by controlling the cooling unit 10, provide a switch to power an internal light, and provide a switch to power on/off the cooling unit 10. The control unit 22 is electrically coupled to a high-voltage power supply, such as the line-in voltage for a building (e.g., 110/120 VAC or higher), a compressor, and other electrically activated and/or powered components.

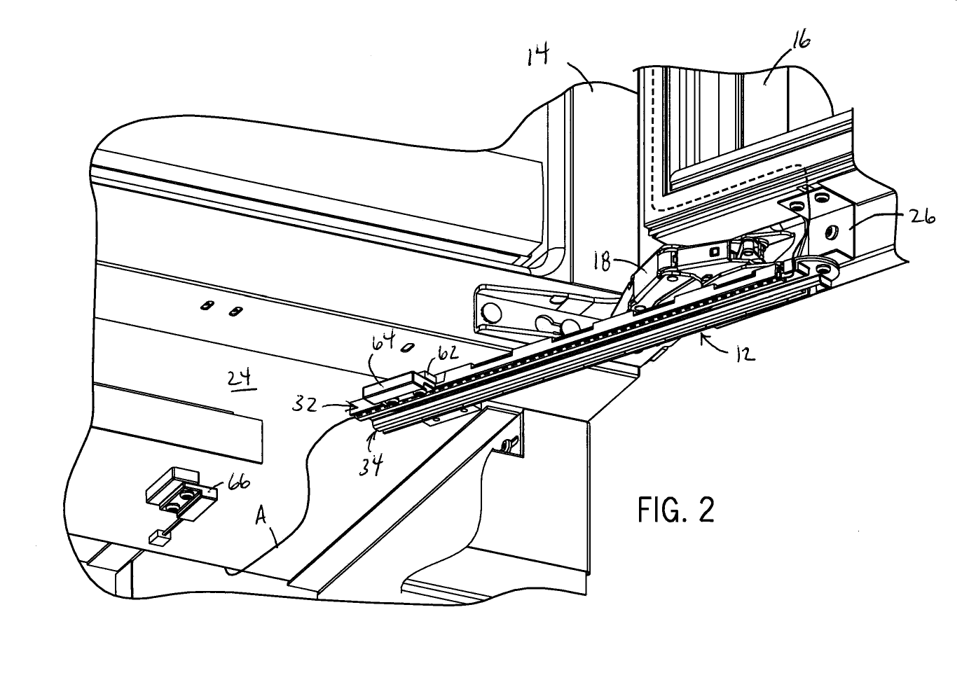

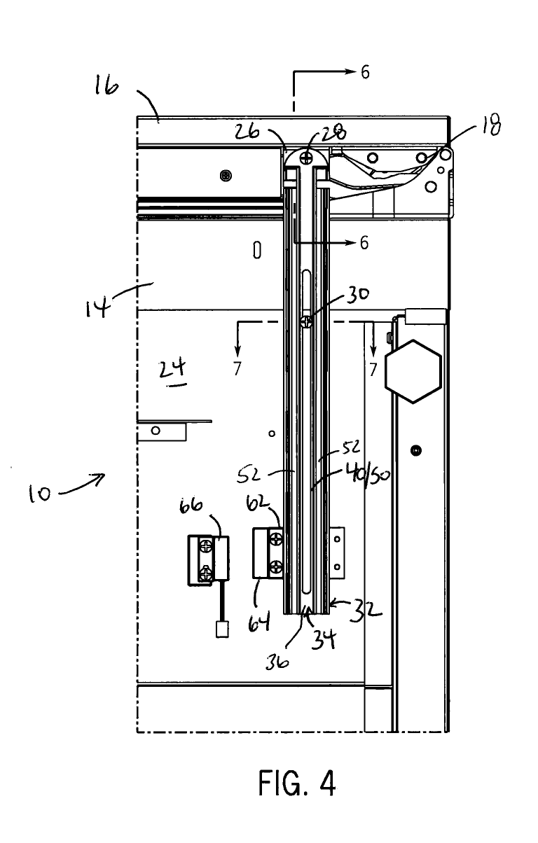

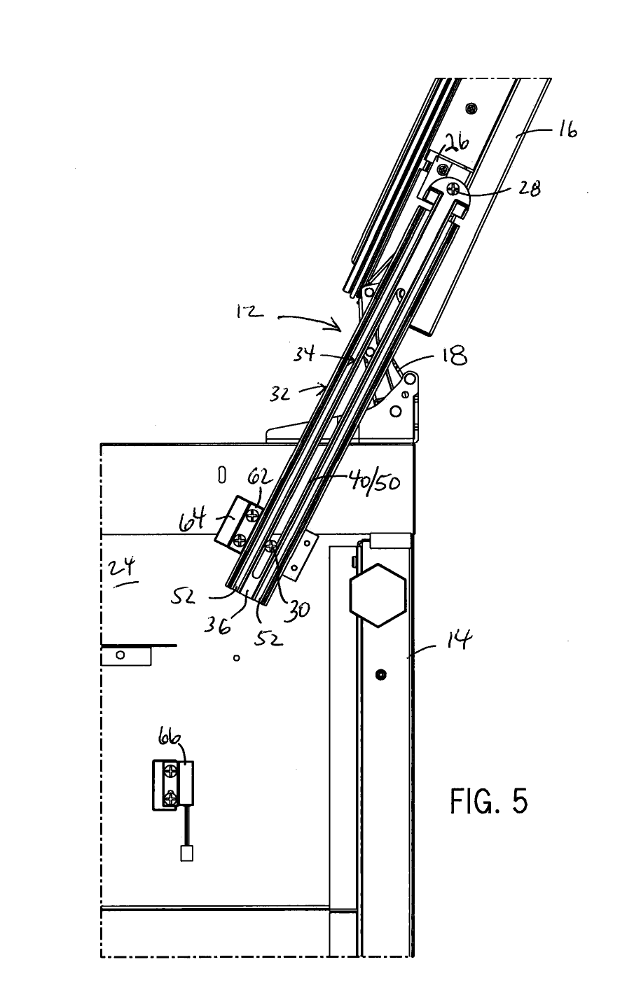

Having generally described an example cooling unit 10, the extender/retractor device 12 will now be described in detail. The extender/retractor device 12 is disposed at the underside of the cooling unit 10 and can be connected at one or both ends to a recessed bottom 24 of the cabinet 14 and/or a bottom of the door 16. As shown in FIGS. 2, 5 and 6, the extender/retractor device 12 is pivotally connected to the door 16 via a mounting bracket 26, mounted to the bottom of the door 16 near the lower hinge 18, and a fastener 28. The extender/retractor device 12 is also linked to the bottom 24 of the cabinet 14 via another fastener 30, as shown in FIGS. 4 and 5. The fasteners 28 and 30 can be bolts, screws, rivets, or any other threaded or unthreaded mechanical fasteners. The fastener 28 travels in an arc path as the door 16 pivots open and closed, and the fastener 30 is stationary, being fixedly mounted to the bottom 24 of the cabinet 14.

As shown in FIGS. 2, 5 and 7, the extender/retractor device 12 can have two parts, an outer backer channel 32 and an inner track 34. The backer channel 32 can have an elongated, generally planar back wall 36 and two short side walls 38 extending perpendicularly from the long edges of the back wall 36 so as to form an open-sided U-channel. The opposite short ends of the backer channel 32 can be open without end walls. The back wall 36 can have a through slot 40 extending in the lengthwise direction and an opening for the door fastener 28. The opening and the slot 40 are sized large enough to accommodate the shanks of the fasteners 28 and 30, respectively, but smaller than the heads of the fasteners. The slot 40 is long enough to prevent the fastener 30 form interfering with the backer channel 32 in a manner that would prevent the door 16 from opening and closing fully. The side walls 38 of the backer channel 32 can have enlarged terminal edges 42 along their entire length, or at discreet wall areas between open windows spaced along their length, that project inwardly to form catch surfaces 44. The enlarged edges 42 can have angled inner corners forming cam surfaces 46 for easing the track 34 into the backer channel 32.

The track 34 can be an elongated piece of a width sized to fit within the open side of the backer channel 32 between the side walls 38. The track 34 can be longer, shorter or the same length as the backer channel 32 and extend to a rounded end having an opening for the fastener 28. The two openings of the backer channel 32 and the track 34 align to couple with the fastener 28, and thereby allow the extender/retractor device 12 to pivot as the door 16 opens and closes. The track 34 also has a long slot 50, sized and located in registration with the slot 40 of the backer channel 32 so that the fastener 30 can fit into the slots 40 and 50 and mount the other end of the extender/retractor device 12 to the cabinet 14. The track 32 can also have one or more troughs 52, such as two or more each running the length of the track 34 generally symmetrically about the long axis of the track 32, or the centerline of the slot 50. The troughs 52 can be an integral part of the track 34 and project outwardly from its spine where slot 50 is formed. The troughs 52 can be open ended in that they communicate with the open ends of the backer channel 32. The long edges of the track 34 form short projections 56 that can cam over, and be captured by, the terminal edges 42 of the backer channel 32 side walls 38 so that they fit within a small space or pocket between, and are captured by the catch surfaces 44 and the back wall 36 of the backer channel 32. The catch surfaces 44 engage the projections 56 and work to retain the track 34 within the backer channel 32. This arrangement also allows the track 34 to be assembled to the backer channel 32 by fitting the protections 56 in the space between the catch surfaces 44 and the back wall 36 and sliding it in place. The parts can be disassembled by sliding the track 34 from an open end of the backer channel 32. Or, if made of a suitably flexible or deflectable material, the track 34 can be readily snapped into the backer channel 32 by pressing the projections 56 past the cam surfaces 46 of the side walls 38. The track 34 could then be disassembled by flexing the side walls 38 outwardly to free the projections 56 from the catch surfaces 44. One or more lines, such as line A shown in FIGS. 1-2 and 6-7, can be disposed in one or more of the troughs 52.

The size, that is the cross-sectional area, of the troughs 52 can be selected according to the gauge size or the type of line, such that the troughs 52 can be larger for lower gauge conductors, conductors with thicker insulation or braiding, or for tubing or hollow conduit which may contain conductors or be part of a sealed plumbing line. The size of the troughs 52 can be selected to press against the line so that a slight clamping force works to resist relative movement of the line and the extender/retractor device 12 through its range of motion. If only a single trough 52 is needed for a particular application, the additional trough can provide for left-hand, right-hand interchangeability. For example, the door 16 could be mounted at the left side of the cabinet (rather than the right side as depicted in FIG. 1), in which case the same location and dimension conditions exist for assembly in either left-hand or right-hand installations using the same extender/retractor device 12.

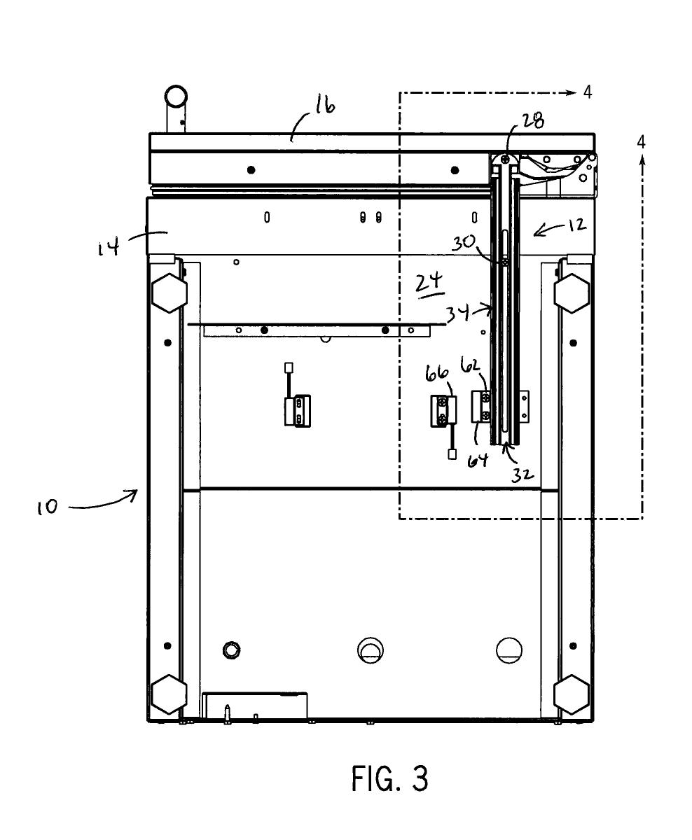

As mentioned, the extender/retractor device 12 supports and carries the lines through the changing distance spanning the cabinet 14 and the door 16 as it opens and closes. FIGS. 3 and 4 illustrate the extender/retractor device 12 when the door 16 is closed. In this position, the extender/retractor device 12 is essentially perpendicular with the front side (and parallel to the sides) of the cabinet 14 and the fasteners 28 and 30 are in front-to-back alignment with the cabinet fastener 30 positioned in the slots 40 and 50 closer to the front end of the extender/retractor device 12. As the door 16 is opened, the extender/retractor device 12 pivots about the door fastener 28 and simultaneously pivots and slides or translates about the cabinet fastener 30. FIGS. 1, 2 and 5 illustrate the extender/retractor device 12 when the door 16 is fully opened in which case it can extend at an angle generally aligned with the angle of the door 12. As shown in FIG. 5, the cabinet fastener 30 is now positioned in the slots 40 and 50 closer to the back end of the extender/retractor device 12. The extender/retractor device 12 makes the reverse movements as the door is returned to the closed position.

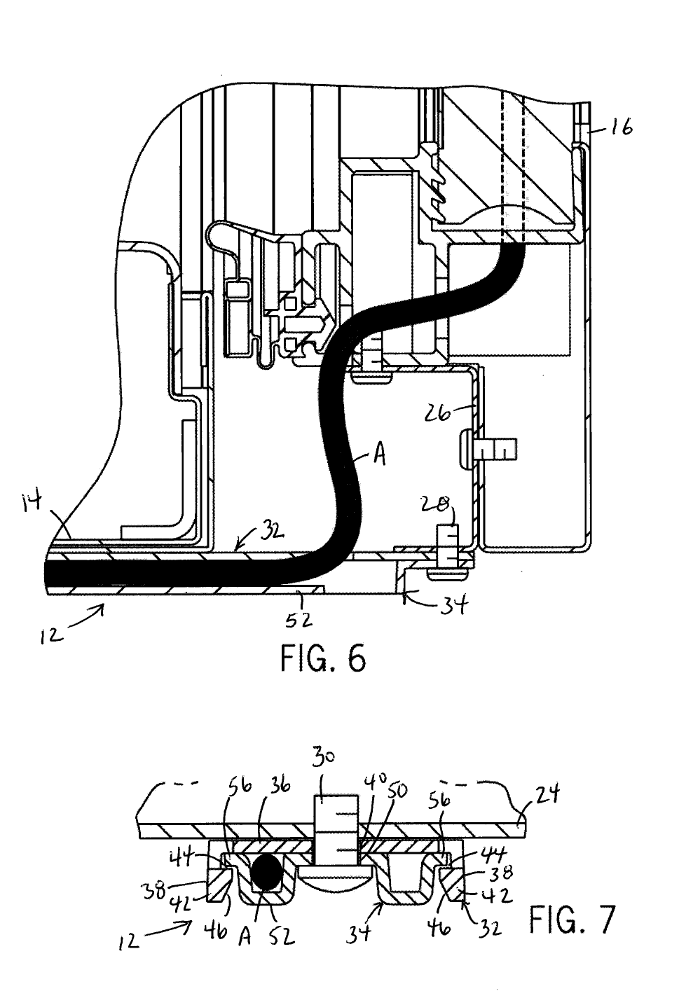

As shown in FIGS. 2 and 6, the line A passes from the cabinet through the cabinet side open end of the extender/retractor device 12 and into and through one of the troughs 52. The line A passes through the opposite door side open end of the extender/retractor device 12 where it routes directly up through internal passages of the door 16. Thus, in the area where movement is required at the exposed area spanning the cabinet 14 and the door 16, the line A is supported throughout the range of movement of the extender/retractor device 12. The line A is left unsupported so it can translate, pivot or flex as needed only at an unexposed interior, back or bottom area of the cabinet 14, such that damage to the lines by pinching, pulling, kinking and the like is significantly reduced. By sizing the troughs 52 appropriately, or through the use of internal ribbing or sizing features (not shown), the line A can be restrained from moving within the extender/retractor device 12, and thereby further reduce the likelihood of damaging the line A as the door 16 is opened and closed.

The extender/retractor device 12 can also include a magnetic switch 60 for operating electrical features of the cooling unit 10, such as a light (not shown) in the cabinet interior. Either the backer channel 32 (as shown in FIGS. 2-5) or the track 34 can have a mount 62 for supporting a component 64 of the switch 60. The mount 62 can be integrally formed with the backer channel 32 or the track 34 or it can be mounted to either component mechanically, and the switch component 64 can be attached to the mount using any suitable mechanical connector, such as adhesives and threaded fasteners. The component 64 is positioned on the backer channel 32 so that the component 64 aligns with a complementary component 66 of the switch 60, which can be fixed to the bottom 24 of the cabinet 14 and electrically connected to the control unit 22 and/or the powered feature, such as the cabinet interior light. As an example, the switch 60 can be a magnetic read switch in which the component 64 mounted to the extender/retractor device 12 is a magnet and the component 66 mounted to the cabinet 14 has reed contacts that change position in the presence of a magnetic field. The switch 60 can be normally closed and be opened by positioning the magnet 64 nearby the reed component 66 (as shown in FIGS. 3 and 4) when the door 16 is closed. When the door 16 is opened, the extender/retractor device 12 pivots to move the magnet 64 away from the reed component 66, as shown in FIG. 5, which allows the reeds to return to the closed position and complete the circuit of the cabinet light. Left-hand, right-hand interchangeability can also be achieved by providing a mount 62 on opposite sides of the extender/retractor device 12 and pre-installing a second switch component 66 on the bottom 24 of the cabinet 14 at the location shown in FIG. 4.

It should be appreciated that the above description describes one or more specific examples of the disclosed installation features for one exemplary type of appliance. However, many modifications and variations in use will be apparent to those skilled in the art, which will be within the spirit and scope of the invention. Therefore, the invention should not be limited to the described examples. To ascertain the full scope of the invention, the following claims should be referenced.

I claim:

1. A device for supporting a line member extending between a housing and a movable closure, the device comprising:
a first part having a first end coupled to one of the housing and the closure and a second end coupled to the other of the housing and the closure, the first part having a back and sides defining a channel therebetween having an open side; and
a second part coupled to the first part at the open side of the channel;
wherein at least one of the first and second parts defines a trough for receiving the line member, wherein the trough opens to the channel and the first and second ends so that the line member can extend therethrough and between the housing and the closure.

2. The device of claim 1, wherein at least one of the first and second parts provides a sliding connection to one of the housing and the closure.

3. The device of claim 2, wherein the sliding connection includes a lengthwise slot in the back wall of the first part.

4. The device of claim 2, wherein at least one of the first and second parts provides a pivotal connection to one of the housing and the closure.

5. The device of claim 1, wherein the second part couples to the first part in a snap-fit.

6. The device of claim 5, wherein the side walls of the first part have inwardly extending projections defining catch surfaces and wherein the sides of the second part have outwardly extending projections that are engaged by the catch surfaces to retain the second part to the first part.

7. The device of claim 6, wherein the projections of the first part have tapered cam surfaces for easing insertion second part into the first part.

8. The device of claim 1, wherein the second part defines two troughs aligned symmetrically with respect to its long axis.

9. The device of claim 1, wherein at least one of the first part and the second part provides a mount for a magnetic switch member.

10. A device for supporting a line member extending between a housing and a movable closure, the device comprising:
a first part having a back and sides defining a channel therebetween, the first part being connectable to the housing in a sliding connection via a lengthwise slot in the back wall of the first part and connectable to the closure via a pivotal connection; and
a second part coupled to the first part within the channel, the second part defining a trough for receiving the line member, wherein the trough opens at ends of the first part so that the line member can extend between the housing and the closure.

11. The device of claim 10, wherein the second part couples to the first part in a snap-fit.

12. The device of claim 11, wherein the side walls of the first part have inwardly extending projections defining catch surfaces and wherein the sides of the second part have outwardly extending projections that are engaged by the catch surfaces to retain the second part to the first part.

13. The device of claim 12, wherein the projections of the first part have tapered cam surfaces for easing insertion of the second part into the first part.

14. The device of claim 10, wherein the second part defines two troughs aligned symmetrically with respect to its long axis.

15. The device of claim 10, wherein at least one of the first and second parts provides a mount for a magnetic switch member.

16. A device for supporting a line member extending between a housing and a movable closure, the device comprising:
a first part connectable to the housing at one end and to the closure at another end, the first part having a back and sides defining a channel therebetween, the sides having inwardly extending projections defining catch surfaces; and
a second part coupled to the first part within the channel in a snap-fit, the second part having outwardly extending projections that are engaged by the catch surfaces to retain the second part to the first part, wherein the second part defines a trough for receiving the line member that opens at the ends of the first part so that the line member can extend between the housing and the closure.

17. The device of claim 16, wherein the projections of the first part have tapered cam surfaces for easing insertion of the second part into the first part.

18. The device of claim 16, wherein one or more of the first and second parts provides a sliding connection to one of the housing and the closure member and a pivotal connection to the other of the housing and closure member.

19. The device of claim 16, wherein the second part defines two troughs aligned symmetrically with respect to its long axis.

20. The device of claim 16, wherein at least one of the first and second parts provides a mount for a magnetic switch member.
